(19) United States
(12) Patent Application Publication
(10) Pub. No.: US 2008/0191474 A1
(43) Pub. Date: Aug. 14, 2008

(54) Tri-Lobed O-Ring Seal

(76) Inventor: George J. Kotz, Dubuque, IA (US)

Correspondence Address: DEERE & COMPANY, ONE JOHN DEERE PLACE, MOLINE, IL, 61265, US

(21) Appl. No.: 11/963,280

(22) Filed: Dec. 21, 2007

Related U.S. Application Data
(63) Continuation-in-part of application No. 11/673,940, filed on Feb. 12, 2007, now abandoned.

(51) Int. Cl. F16L 37/138

(52) U.S. Cl. 285/276; 277/500

(57) ABSTRACT

A joint comprises first and second components and a tri-lobed O-ring seal establishing a sealed connection between the first and second components.

The present application claims the benefit under 35 U.S.C. §120 of U.S. patent application Ser. No. 11/673,940, filed Feb. 12, 2007, as a continuation-in-part thereof.

### FIELD OF THE DISCLOSURE

The present disclosure relates to O-ring seals.

### BACKGROUND OF THE DISCLOSURE

O-ring seals are used to establish a sealed connection between components. O-ring seals are used in a wide variety of applications.

### SUMMARY OF THE DISCLOSURE

According to the present disclosure, there is provided a joint comprising first and second components and a tri-lobed O-ring seal establishing a sealed connection between the first and second components. The O-ring seal comprises only three lobes in a transverse cross-section of the O-ring seal such that first and second lobes of the three lobes are positioned within an annular groove of the first component, a lip of the annular groove retains the first lobe in the annular groove, and the third lobe of the three lobes contacts, and is compressed by, the second component without tilting of the third lobe. Such configuration of the joint and O-ring seal is especially useful in relatively high pressure applications, but could be used in other applications as well.

The above and other features will become apparent from the following description and the attached drawings.

### BRIEF DESCRIPTION OF THE DRAWINGS

The detailed description of the drawings refers to the accompanying figures in which:

FIG. 1 is a plan view of a tri-lobed O-ring seal;

FIG. 2 is a sectional view taken along lines 2-2 of FIG. 1 showing the tri-lobed O-ring seal in transverse cross-section positioned within an annular groove of a first component (the phantom lines representing portions of the O-ring seal in its relaxed state); and

FIG. 3 is a sectional view similar to FIG. 2 showing the O-ring seal establishing a sealed connection between the first component and a second component.

### DETAILED DESCRIPTION OF THE DRAWINGS

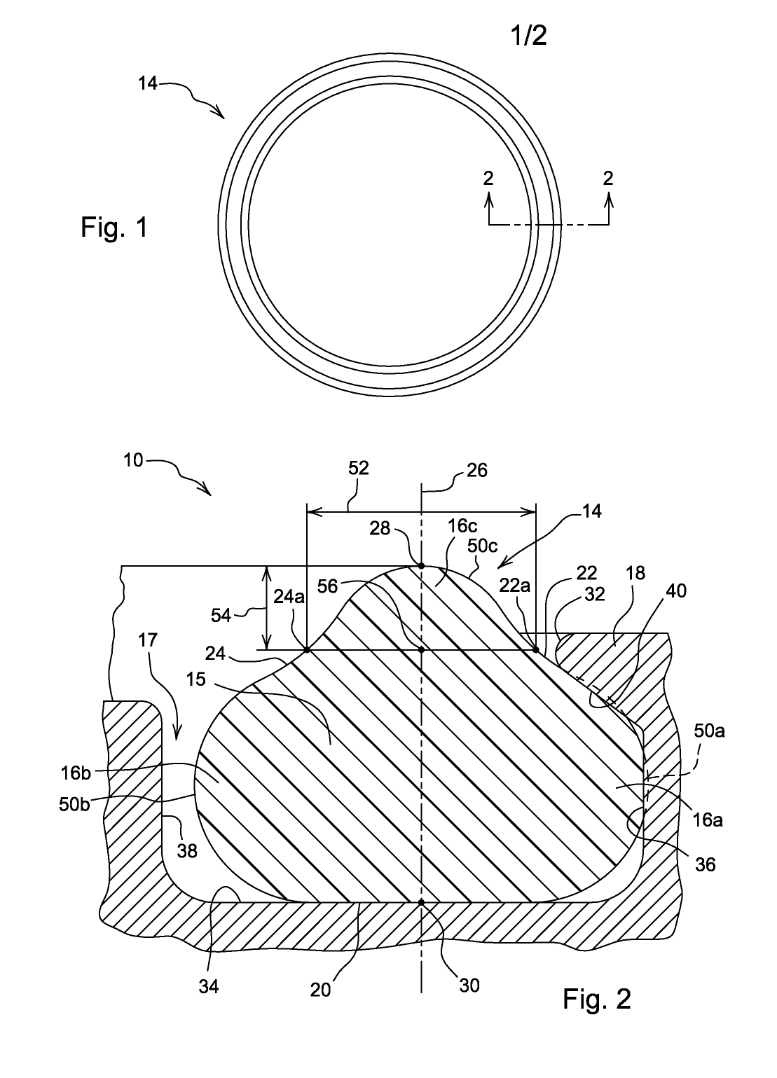

Referring to FIGS. 1-3, a joint 10 comprises first and second components 12a, 12b and a tri-lobed O-ring seal 14. The O-ring seal 14 establishes a sealed connection between the first and second components 12a, 12b. The O-ring seal 14 comprises only three lobes in a transverse cross-section 15 of the O-ring seal 14 such that first and second lobes 16a, 16b of the three lobes are positioned within an annular groove 17, a lip 18 of the annular groove 17 retains the first lobe 16a in the annular groove 17, and the third lobe 16c of the three lobes contacts, and is compressed by, the second component 12b without tilting of the third lobe 16c. What is meant herein by the term “lobe” is a rounded projection.

Such a tri-lobe shape facilitates retention of the O-ring seal 14 in the groove 12 while enabling sealing contact of the O-ring seal 14 with the second component 12b. The lack of tilting of the third lobe 16c in response to compression by the second component 12b upon assembly of the joint 10 promotes use of the seal 14 in relatively high pressure applications. For example, the seal 14 may be used in the joints of hydraulic systems (e.g., brake system, cooling system, transmission system, or work implement operating system), air conditioning systems, and the like to establish a sealed connection between components thereof (e.g., hydraulic lines, hydraulic line and other component, condenser and conduit, or other components). In particular, the seal 14 may be used to effect a seal in the joint 10 at a working pressure of, for example, 6000 psi, to withstand a burst pressure of, for example, 24,000 psi, and to endure an impulse-cycle test of, for example, 133% of the working pressure (e.g., 7980 psi) for 1 million cycles. The seal 14 may be made of rubber or other elastomeric material. The seal 14 may thus be used as a face seal between components 12a, 12b.

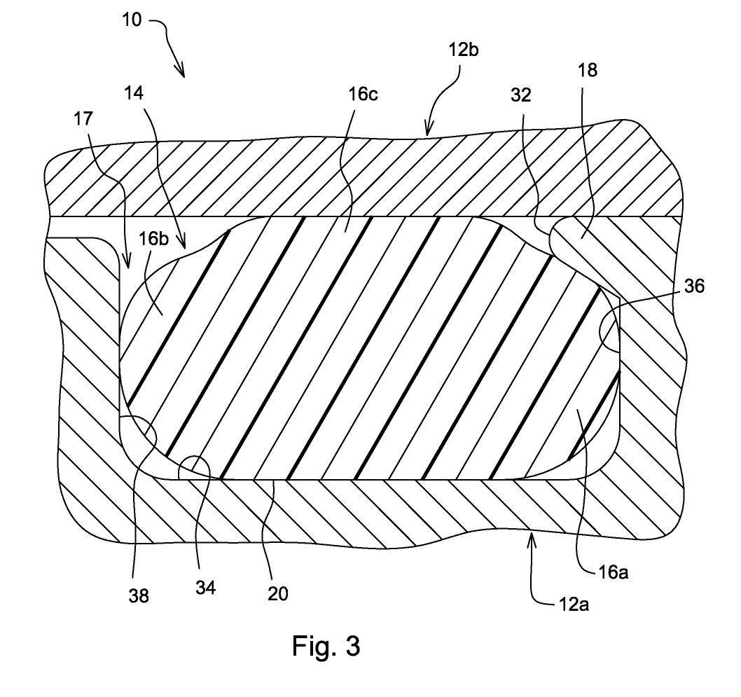

Referring to FIG. 2, an exemplary configuration of the O-ring seal 14 is provided. The first and second lobes 16a, 16b are positioned about 180 degrees from one another and are positioned within the groove 12 when the O-ring seal 14 is installed. The third lobe 16c is positioned about 90 degrees from each of the first and second lobes 16a, 16b and extends outside the groove 12 for contact with the mating component 12b in the absence of compression of the third lobe 16c by the component 12b. The O-ring seal 14 comprises a flat surface 20 connecting the first and second lobes 16a, 16b opposite the third lobe 16c. The O-ring seal 14 is symmetrical about an imaginary line 26 extending in the transverse cross-section 15 from a midpoint 28 of the third lobe 16c to a midpoint 30 of the flat surface 20.

In a relaxed state of the O-ring seal 14 (as indicated by the phantom lines of FIG. 2), each of the three lobes 16a, 16b, 16c is rounded. As such, the lobes 16a, 16b, 16c have convex surfaces 50a, 50b, 50c, respectively, the first and third lobes 16a, 16c cooperate to provide a first concave surface 22 the midpoint 22a of which defines where the first and third lobes 16a, 16c meet one another, and the second and third lobes 16b, 16c cooperate to provide a second concave surface 24 the midpoint 24a of which defines where the second and third lobes 16b, 16c meet one another. The convex surfaces 50a, 50c meet the first concave surface 22 without any straight surfaces therebetween, and the convex surfaces 50b, 50c meet the second concave surface 24 without any straight surfaces therebetween. Each lobe 16a, 16b, 16c is thus curved so as to be devoid of any straight surfaces in the relaxed state of the O-ring seal 14.

Further, in the relaxed state, each convex surface 50a, 50b, 50c has an outer radius, and each concave surface 22, 24 has an inner radius. The outer radii of the convex surfaces 50a, 50b are substantially equal to one another (e.g., outer radius of surfaces 50a, 50b is 0.62 mm ±0.08 mm), and the inner radii are substantially equal to one another (e.g., inner radius of surfaces 22, 24 is 1.00 mm ±0.08 mm), the term “substantially equal” meaning that the respective radii are within suitable manufacturing tolerances of one another. The outer radius of the convex surface 50c may be smaller than the outer radii of the convex surfaces 50a, 50b (e.g., outer radius of surface 50c is 0.5 mm ±0.08 mm). Each of the inner radii is greater than the outer radius of the convex surface 50c; indeed, a ratio of each of the inner radii to the outer radius of the surface 50c is about 2:1, promoting the lack of tilting of the third lobe 16c upon assembly of the joint 10.

A ratio of height to width of the third lobe 16c may be, for example, less than 0.5, also to promote the lack of tilting of the third lobe 16c upon assembly of the joint 10. The width 52 of the third lobe 16c is the distance between the midpoint 22a of the first concave surface 22 and the midpoint 24a of the second concave surface 24. The height 54 of the third lobe 16c is the distance between a midpoint 56 of the width 52 and the midpoint of the convex surface 50c of the third lobe 16c, the midpoint of the convex surface 50c defining the midpoint 28 of the third lobe 16c. The height-to-width ratio of the third lobe 16c may be, for example about 0.36.

The groove 12 is shaped generally as a half-dovetail configuration. It comprises a mouth 32, a base wall 34 facing the mouth 32, radially outer and inner side walls 36, 38 facing one another and extending axially outwardly from the base wall 34, and the lip 18 projecting radially inwardly from the side wall 36 at the mouth 32.

The seal 14 is installed into the groove 12. The flat surface 20 abuts the base wall 34, providing robust contact with the base wall 34. The first lobe 16a is trapped between the lip 18 and the base wall 34 such that the first and second lobes 16a, 16b are retained in the groove 12 while the third lobe 16c extends through the mouth 32 outside the groove 12 in the absence of compression of the third lobe 16c by the second component 12b when the joint 10 is disassembled. The first lobe 16a may thus be compressed somewhat by contact with the side wall 36 and an angled surface 40 of the lip 18. The second lobe 16b is spaced apart from the radially inner side wall 28 in the absence of compression of the third lobe 16c by the second component 12c and contacts the radially inner side wall 28 so as to be compressed somewhat thereby in response to compression of the third lobe 16c by the second component 12c.

The rounded shape of the lobes 16a, 16b, 16c offers benefits over, for example, seals which may have sharp corners (e.g., the corners of a trapezoid-shaped O-ring seal). Such benefits include, but are not limited to, the following: ease of manufacturing seal molds due to rounded shape of lobes, sharp corners in molds may cause more air to be trapped than rounded shape of lobes when producing O-ring seals, sharp corner O-ring seals tend to have more scrap waste, sealing forces are typically higher for rounded shape, and ease of installation due to rounded shape of lobes.

Referring to FIG. 3, the seal 14 establishes a sealed connection between the components 12a, 12b upon assembly of the joint 10. Exemplarily, the components 12a, 12b component 12b abut one another in face-to-face contact. A surface 60 of the first component 12a, part of which is provided by the lip 18, mates against a surface 62 of the second component 12b. The surface 62 compresses the third lobe 16c without tilting of the lobe 16c upon contact with the surface 60. Avoidance of tilting of the third lobe 16c facilitates establishment of the sealed connection for use in relatively high pressure applications, unlike lip seals which may tend to tilt upon assembly of the joint. The lip 18 retains the first lobe 16a in the groove 17 such that the first lobe 16a is trapped between the lip 18 and the wall 20. The lobe 16b bulges toward the inner wall 38 into contact therewith, facilitating retention of the seal 14 in the groove 17. The configuration of the tri-lobed seal 14 thus promotes retention of the seal 14 in the groove 17 so as to inhibit pop-out of the seal 14 from the groove 17 and provides an effective sealed connection for relatively high pressure applications (e.g., working pressure of 6000 psi). It is to be understood that the seal 14 could also be used for lower pressure applications.

The joint 10 and seal 14 thereof may be used in a wide variety of vehicles and other machines, including, but not limited to, construction equipment, forestry equipment, agricultural equipment, lawn, garden, and turf equipment, and the like, to name just a few.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A joint, comprising:
first and second components, the first component comprising an annular groove, and
an O-ring seal establishing a sealed connection between the first and second components, the O-ring seal comprising only three lobes in a transverse cross-section of the O-ring seal such that first and second lobes of the three lobes are positioned within the annular groove, a lip of the annular groove retains the first lobe in the annular groove, and the third lobe of the three lobes contacts, and is compressed by, the second component without tilting of the third lobe.

2. The joint of claim 1, wherein, in a relaxed state of the O-ring seal, the third lobe is curved so as to be devoid of any straight surfaces.

3. The joint of claim 1, wherein the first and second lobes are positioned about 180 degrees from one another and the third lobe is positioned about 90 degrees from each of the first and second lobes, the O-ring seal comprises a flat surface connecting the first and second lobes opposite the third lobe, and, in a relaxed state of the O-ring seal, the first and third lobes cooperate to provide a first concave surface the midpoint of which defines where the first and third lobes meet one another, the second and third lobes cooperate to provide a second concave surface the midpoint of which defines where the second and third lobes meet one another, the third lobe comprises a convex surface the midpoint of which defines a midpoint of the third lobe, and the convex surface meets the first concave surface without any straight surfaces therebetween and meets the second concave surface without any straight surfaces therebetween.

4. The joint of claim 3, wherein the first concave surface is a first inner radius, the second concave surface is a second inner radius, and the convex surface is an outer radius.

5. The joint of claim 4, wherein the first inner radius and the second inner radius are substantially equal to one another, and each of the first inner radius and the second inner radius is greater than the outer radius.

6. The joint of claim 5, wherein a ratio of each of the first inner radius and the second inner radius to the outer radius is about 2:1.

7. The joint of claim 3, wherein a ratio of height to width of the third lobe is less than 0.5, the width being the distance between the midpoint of the first concave surface and the midpoint of the second concave surface, the height being the distance between a midpoint of the width and the midpoint of the convex surface of the third lobe.

8. The joint of claim 7, wherein the height-to-width ratio of the third lobe is about 0.36.

9. The joint of claim 3, wherein the O-ring seal is symmetrical about an imaginary line extending in the transverse cross-section from the midpoint of the third lobe to a midpoint of the flat surface, the groove is shaped as a half-dovetail configuration so as to comprise a base wall, a side wall, and the lip projecting from the side wall at a mouth of the groove, the flat surface abuts the base wall, the first lobe is trapped between the lip and the base wall such that the first and second lobes are retained in the groove, the first lobe abuts the lip and the side wall, and the third lobe extends outside the groove in the absence of compression of the third lobe by the second component.

10. The joint of claim 1, wherein the groove comprises a base wall, a side wall, and the lip projecting radially from the side wall, and the first lobe is trapped between the lip and the base wall.

11. The joint of claim 10, wherein the first lobe contacts the lip and the side wall.

12. The joint of claim 11, wherein the side wall is a radially outer side wall, the groove comprises a radially inner side wall facing the radially outer side wall, the second lobe is spaced apart from the radially inner side wall in the absence of compression of the third lobe by the second component and contacts the radially inner side wall in response to compression of the third lobe by the second component.

13. The joint of claim 1, wherein the groove comprises a base wall facing a mouth of the groove, and the O-ring seal comprises a flat surface connecting the first and second lobes and abutting the base wall.

14. The joint of claim 1, wherein the third lobe extends outside the groove when the first and second lobes are positioned within the annular groove and the third lobe is uncompressed by the second component.

15. An O-ring seal adapted to establish a sealed connection between first and second components, the O-ring seal comprising only three lobes in a transverse cross-section of the O-ring seal such that first and second lobes of the three lobes are adapted to be positioned within an annular groove of the first component, the first lobe is adapted to be retained in the annular groove by a lip of the annular groove, and the third lobe of the three lobes is adapted to contact, and be compressed by, the second component without tilting of the third lobe.

16. The O-ring seal of claim 15, wherein the first and second lobes are positioned about 180 degrees from one another and the third lobe is positioned about 90 degrees from each of the first and second lobes, the O-ring seal comprises a flat surface connecting the first and second lobes opposite the third lobe, and, in a relaxed state of the O-ring seal, the first and third lobes cooperate to provide a first concave surface the midpoint of which defines where the first and third lobes meet one another, the second and third lobes cooperate to provide a second concave surface the midpoint of which defines where the second and third lobes meet one another, the third lobe comprises a convex surface the midpoint of which defines a midpoint of the third lobe, and the convex surface meets the first concave surface without any straight surfaces therebetween and meets the second concave surface without any straight surfaces therebetween.

17. The O-ring seal of claim 16, wherein the first concave surface is a first inner radius, the second concave surface is a second inner radius, and the convex surface is an outer radius.

18. The O-ring seal of claim 17, wherein the first inner radius and the second inner radius are substantially equal to one another, and each of the first inner radius and the second inner radius is greater than the outer radius.

19. The O-ring seal of claim 18, wherein a ratio of each of the first inner radius and the second inner radius to the outer radius is about 2:1, and a ratio of height to width of the third lobe is about 0.36, the width being the distance between the midpoint of the first concave surface and the midpoint of the second concave surface, the height being the distance between a midpoint of the width and the midpoint of the convex surface of the third lobe.

20. An O-ring seal comprising only three lobes in a transverse cross-section of the O-ring seal, wherein the first and second lobes are positioned about 180 degrees from one another and the third lobe is positioned about 90 degrees from each of the first and second lobes, the O-ring seal comprises a flat surface connecting the first and second lobes opposite the third lobe, and, in a relaxed state of the O-ring seal, the third lobe is curved so as to be devoid of any straight surfaces.
